(19) United States
(12) Patent Application Publication
(10) Pub. No.: US 2017/0126427 A1
(43) Pub. Date: May 4, 2017

(54) MOTOR CONTROLLER ATTAINING BOTH LOW LATENCY AND HIGH THROUGHPUT DATA COMMUNICATIONS

(71) Applicant: FANUC CORPORATION, Yamanashi (JP)

(72) Inventor: Masahiro TSUJI, Yamanashi (JP)

(21) Appl. No.: 15/275,480

(22) Filed: Sep. 26, 2016

(30) Foreign Application Priority Data
Oct. 28, 2015 (JP) 2015-211993

(51) Int. Cl. H04L 12/40

(52) U.S. Cl. CPC H04L 12/4015; H04L 12/4013; H04L 12/40032

(57) ABSTRACT

A motor controller includes a first circuit device and a second circuit device, and is configured to carry out data communication between the first circuit device and the second circuit device via at least two communication channels of different communication properties, wherein the data communication between the first circuit device and the second circuit device includes a first data communication in which low latency is requested and a second data communication in which high throughput is requested, and the first data communication is carried out between the first circuit device and the second circuit device via a first communication channel of a low latency property, and the second data communication is carried out between the first circuit device and the second circuit device via a second communication channel of a high throughput property.

### RELATED APPLICATIONS

The present application claims priority to Japanese Patent Application Number 2015-211993 filed Oct. 28, 2015, the disclosure of which is hereby incorporated by reference herein in its entirety.

### BACKGROUND OF THE INVENTION

1. Field of the Invention

The present invention relates to a motor controller which can attain both a data communication in which low latency is requested and a data communication in which high throughput is requested.

2. Description of the Related Art

In recent years, in order to realize a reduction in the number of components and a reduction of an occupied area, ASIC (Application Specific Integrated Circuit) in which a variety of circuit blocks (functional macros) are integrated, has been used for an electronic device such as a motor controller, etc.

For example, in the motor controller for controlling a motor in a machine tool or a robot, etc., for example a main CPU (Central Processing Unit) and ASIC in which a plurality of circuit blocks are integrated to exhibit different functions respectively, are connected via a bus so that transmission and reception of various signals (command signals and data signals, etc.) are carried out between the main CPU and ASIC.

In the communication (transmission and reception of signals) between the main CPU and ASIC, there are coexistence of a data communication in which low latency (short delay time) is requested, and a data communication in which high throughput (large number of transmissions per unit time) is requested, in accordance with a property, etc., of each circuit block included in ASIC.

Therefore, for example, in order to improve a performance of the motor controller for controlling the motor in the machine tool or the robot, etc., it is preferable to attain and process both of the abovementioned different kind of data communications.

Conventionally, for example, to improve the communication between the main CPU (a first circuit device) and ASIC (a second circuit device), there are various proposals. For example, Japanese Patent No. 4558519 (patent document 1) discloses a data communication in which a transmission speed is improved by connecting a controller and PCI-EX device by a plurality of lanes, as a system of connecting devices via PCI Express (registered trademark) (also referred to as PCI-EX hereafter).

Further, Japanese Laid-open Patent Publication No. 2013-054730 (patent document 2) discloses, as a numerically controlled system having a multi-core processor, as follows: a reduction of a cost and a mounting area is realized by using an interface of a high-speed serial communication such as PCI Express (registered trademark), Hyper Transport (registered trademark), or Rapid I0 (registered trademark), and the number of signal pins is more reduced than a case of using an interface of a parallel communication.

Further, Japanese Laid-open Patent Publication No. 2008-204245 (patent document 3) discloses as follows: a virtual mode of PCI-EX (PCI Express (registered trademark)) is used, for efficiently handling data processing when an error occurs, at a low cost, with less retransmission overhead, even for an application of a strong restriction such as a synchronous transmission in which transmission of a certain amount of data must be finished without fail in a short period of time.

As described above, for example, in the communication between the main CPU and ASIC, a plurality of circuit blocks are integrated in ASIC to exhibit different functions respectively. Therefore, there are coexistence of the data communication in which low latency is requested (referred to as low latency data communication hereafter), and the data communication in which high throughput is requested (referred to as high throughput data communication hereafter).

However, the conventional motor controller involves a problem to be solved as follows: the data communication is carried out between circuit devices, for example, via one communication channel (bus), and therefore the low latency data communication is kept waiting, and a transmission speed of the high throughput data communication is decreased.

Further, for example patent document 1 discloses a technique of improving a transmission speed by carrying out data communication between circuit devices by a plurality of lanes. Further patent document 2 discloses a technique of reducing a cost and a mounting area by using an interface of a serial communication. Therefore the technique of patent document 1 is different from the data communication in which different kind of data communication is carried out via a different communication channel of a different property.

Then, patent document 3 discloses a technique of using a virtual mode of PCI-EX (PCI Express (registered trademark)) for efficiently handling data processing when an error occurs, at a low cost, with less retransmission overhead, even for an application of a strong restriction such as a synchronous transmission. Therefore the technique of patent document 3 is different from the data communication in which different data communication is carried out via a different communication channel of a different property.

In view of the above-described problems of the conventional techniques, an object of the present invention is to provide a motor controller for attaining both low latency and high throughput in data communication between different circuit devices, corresponding to each property of (different communication channels).

### SUMMARY OF INVENTION

According to a first aspect of the present invention, there is provided a motor controller including a first circuit device and a second circuit device, and configured to carry out data communication between the first circuit device and the second circuit device via at least two communication channels of different communication properties, wherein the data communication between the first circuit device and the second circuit device includes a first data communication in which low latency is requested and a second data communication in which high throughput is requested, and the first data communication is carried out between the first circuit device and the second circuit device via a first communication channel of a low latency property, and the second data communication is carried out between the first circuit device and the second circuit device via a second communication channel of a high throughput property.

The first communication channel may be a first serial bus of a low latency property which is obtained by adjusting a first buffer size, a first payload size, and the number of first lanes, and the second communication channel may be a second serial bus of a high throughput property which is obtained by adjusting a second buffer size, a second payload size, and the number of second lanes. The first buffer size may be smaller than the second buffer size. The second payload size may be larger than the first payload size, or the number of second lanes may be larger than the number of first lanes. The first serial bus and the second serial bus may be PCI Express (registered trademark).

The first communication channel may be a parallel bus, and the second communication channel may be a high-speed serial bus. The parallel bus may be one of PCI, IFC, ATA, 60x, and a boot interface, and the high-speed serial bus may be one of PCI Express (registered trademark), HyperTransport (registered trademark), and Rapid I0 (registered trademark).

According to a second aspect of the present invention, there is provided a motor controller, including a first circuit device and a second circuit device, and configured to carry out data communication between the first circuit device and the second circuit device via a communication channel, wherein the communication channel includes at least two virtual-mode channels in a high-speed serial bus, and data communication is carried out via at least two virtual-mode channels, so that a first priority of first data is placed higher than a second priority of second data whose size is larger than the size of the first data.

The high-speed serial bus may be PCI Express (registered trademark), the first data may be data for which low latency is requested, and the second data may be data for which high through put is requested.

First data transmitted through the first data communication may include data regarding one of a register or a peripheral, and second data transmitted through the second data communication may include data regarding one of a servo, a spindle, I/O, or graphics. The first circuit device may be a first semiconductor integrated circuit, and the second circuit device may be a printed board in which a plurality of semiconductor integrated circuits are provided.

The first circuit device may be a first semiconductor integrated circuit, and the second circuit device may be a second semiconductor integrated circuit in which a plurality of circuit macros are provided. The second semiconductor integrated circuit may be an Application Specific Integrated Circuit of the motor controller. The Application Specific Integrated Circuit may include one of a servo control unit that controls a servo motor or a spindle motor, a graphic engine that applies processing to images, and an I/O communication master that controls I/O communication, which are configured to handle high throughput data; and a peripheral that handles data for which low latency is requested. The first semiconductor integrated circuit may be a main CPU of the motor controller.

### BRIEF DESCRIPTION OF THE DRAWINGS

The present invention will be more clearly understood by reference to the accompanying drawings, in which:

FIGS. 1(a) to 1(d) are block diagrams schematically illustrating a motor controller according to each example of the present invention;

FIG. 2 is a block diagram illustrating a modified example of the motor controller illustrated in FIGS. 1(a) to 1(d);

FIG. 3 is a block diagram illustrating an important part of the motor controller according to a first example of the present invention;

FIG. 4 is a view (Version 1) for describing a configuration and a setting example of the motor controller according to a first example illustrated in FIG. 3;

FIGS. 5(a) to 5(c) are views (Version 2) for describing a configuration and a setting example of the motor controller according to a first example illustrated in FIG. 3;

FIG. 6 is a block diagram illustrating an important part of the motor controller according to a second example of the present invention;

FIG. 7 is a block diagram illustrating an important part of the motor controller according to a third example of the present invention; and

FIGS. 8(a) and 8(b) are views for describing an example of the motor controller.

### DETAILED DESCRIPTION

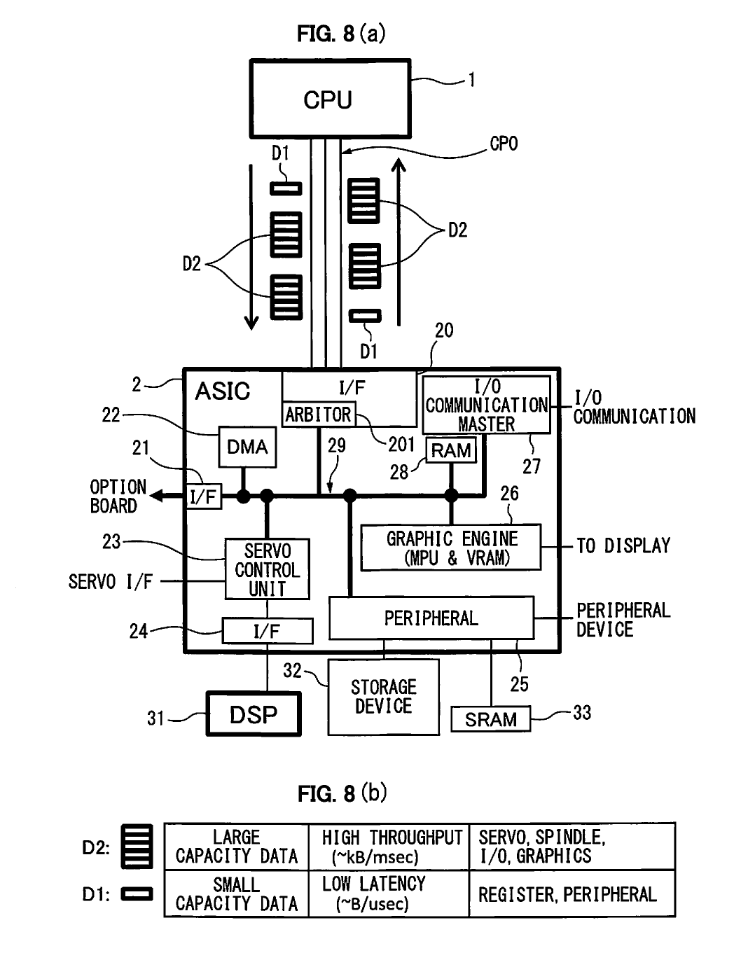

An example of a motor controller and a problem involved therein will be described first with reference to FIGS. 8(a) and 8(b), before the motor controller according to an example of the present invention is described in detail. FIGS. 8(a) and 8(b) are views for describing an example of the motor controller, wherein FIG. 8(a) is a block diagram illustrating an example of the motor controller, and FIG. 8(b) is a view illustrating the kind of data processed by the motor controller illustrated in FIG. 8(a).

As illustrated in FIG. 8(a), the motor controller includes CPU (main CPU: a first circuit device) 1, a facing device (ASIC: a second circuit device) 2, and DSP (Digital Signal Processor) 31. Further, the motor controller may include a storage device 32 and SRAM (Static Random Access Memory) 33. In addition, SRAM 33 is backed up by a battery, but it is also acceptable to use other non-volatile memory such as a flash memory, etc.

ASIC 2 includes interface (I/F) 20 to which CPU 1 is connected, I/F 21 to which an option board (not illustrated) is connected, DMP (Direct Memory Access) 22, and a servo control unit 23. ASIC 2 further includes I/F 24 to which DSP 31 is connected, peripheral 25 to which a variety of peripheral devices are connected, graphic engine 26, and I/O communication master 27.

The I/O communication master 27 is a circuit for controlling the I/O communication, and for example transmits and outputs output data (DO) to a slave unit (not illustrated) via I/O communication, the output data (DO) being stored in RAM (Random Access Memory: RAM for I/O) 28 which is configured to store images of I/O. In FIG. 8(a), the I/O communication master 27 is configured to control the I/O communication, but it is a matter of course that the I/O communication master 27 can be modified in various ways.

Further, for example, the data inputted in the slave unit is stored in RAM 28 as input data (DI) via I/O communication. DI/DO stored in RAM 28 is read and written, for example according to a sequence program executed by CPU 1. CPU 1 may be configured as a multi-core CPU.

The graphic engine 26 is a processor that assists a part of advanced graphics facility, and includes for example VRAM (Video RAM: video memory) that stores image data on a screen, and MPU (Micro Processing Unit: microprocessor) that outputs data stored in VRAM to a display (such as LCD (Liquid Crystal Display), etc.

The peripheral 25 is a unit to which a variety of peripheral devices are connected, such as a storage device 32 including eMMC (registered trademark) (embedded Multi Media Card), SD card, and eSSD (embedded Solid State Device) in which software of the motor controller is stored, SRAM 33, a keyboard, A.SP/HDI, and RTC, etc.

A.SP shows an analog output (analog spindle output), and HDI shows a skip signal input I/F for inputting a signal for skipping an active processing program. HDI may be used as input I/F for a signal of a touch sensor, and functions as an input data (DI) interface for the sensor. Further, RTC shows a real-time digital clock configured by a quartz crystal unit (oscillator) and a counter circuit thereof, and is operated by a battery or a capacitor.

I/F 24 is an interface to which DSP 31 is connected, and configured to transmit and receive signals to and from the servo control unit (spindle/servo control unit) 23. For example a shift command value obtained from CPU 1 is written in an embedded RAM region of the servo control unit 23, and DSP 31 reads the shift command value and controls to shift a motor to a position indicated by the command value. DSP 31 is configured for example as multi-core DSP. Further, the motor is controlled via servo I/F connected to the servo control unit 23.

The servo I/F is an interface for connecting a servo amplifier and a spindle amplifier. A power line communicated to the servo motor and the spindle motor for operating each spindle of a machine tool, and an input line of a feedback signal for detecting a position and a speed of each motor, are connected to the above amplifiers.

In other words, a current command value is transmitted to the amplifier from the servo control unit 23 via the servo I/F. Based on the received current command value, the amplifier performs current control based on PWM (Pulse Width Modulation) signal, and transmits the value of a current sensor incorporated in the amplifier, to the servo control unit 23 via the servo I/F. Further, the feedback signal from the motor is also transmitted to the servo control unit 23 via the servo I/F.

Based on the received values of the current sensor and the feedback signal, DSP 31 transmits the next current control command value to the amplifier via the servo I/F. Further, DSP 31 controls the motor by repeatedly performing such a current control so that each spindle reaches the position indicated by the shift command value as instructed by CPU 1. Then, DSP 31 writes the value of the feedback signal in the servo control unit 23, and CPU 1 reads the written value and confirms the arrival of the spindle at the position indicated by the shift command value.

DSP 31 may be incorporated in CPU 1 which is configured as a multi-core, and in this case, data of the shift command value is exchanged between DSP 31 (Core for DSP 31) in the multi-core and CPU 1 (Core for CPU 1), not through the servo control unit, but through a DRAM or CPU internal cache memory connected to CPU 1.

DMA 22 controls to directly transmit the data stored in RAM 28 and VRAM of the graphic engine 26, or the data to be stored, via an internal bus 29, not based on transmission control by CPU 1. Further, DMA 22 sometimes controls to directly transmit the high throughput data to the option board connected via I/F 21. I/F 20 includes an arbiter (bus arbiter) 201, and control to adjust data communication (transmission and reception of signals) between ASIC 2 and CPU 1.

In FIG. 8(a), CPU 1 and ASIC 2 are connected by a communication channel CP0, and are configured to transmit and receive a variety of data. In other words, the data communication between CPU 1 and ASIC 2 carried out via I/F 20, includes for example a skip signal for skipping an active processing program or input data for a sensor, or a real-time digital clock signal or low latency data D1 inputted from the storage device 32 and transmitted from the peripheral 25, and high throughput data D2 stored in RAM 28 and VRAM of the graphic engine 26 controlled by DMA 22. Low latency data D1 includes the data of a register that performs various settings in various circuit blocks included in ASIC 2.

In other words, even when a high-speed serial bus such as PCI-EX is used as a communication channel CP0, in the data transmitted and received to/from the CPU 1 and ASIC 2 via the communication channel CP0, there is a coexistence of the low latency data D1 and the high throughput data D2.

As illustrated in FIG. 8(b), the low latency data (first data) D1 for which low latency (for example, bytes per microsecond: B/u(μ)sec) is requested, is small capacity data related to the register and the peripheral 25, and the high throughput data (second data) D2 for which high throughput (for example kilobytes per miriseond: kB/msec) is requested, is large capacity data related to the servo, the spindle, I/O or the graphics.

As described above, the high-speed serial bus can be used as the communication channel CP0, but in this case, the low latency data D1 and the high throughput data D2 are communicated between CPU 1 and ASIC 2 via the same communication channel. In other words, in the motor controller illustrated in FIG. 8(a), the data communication is carried out between CPU 1 and ASIC 2 via the same communication channel (bus), thus involving a problem that the low latency data communication is kept waiting, or the transmission speed of the high throughput data communication is decreased.

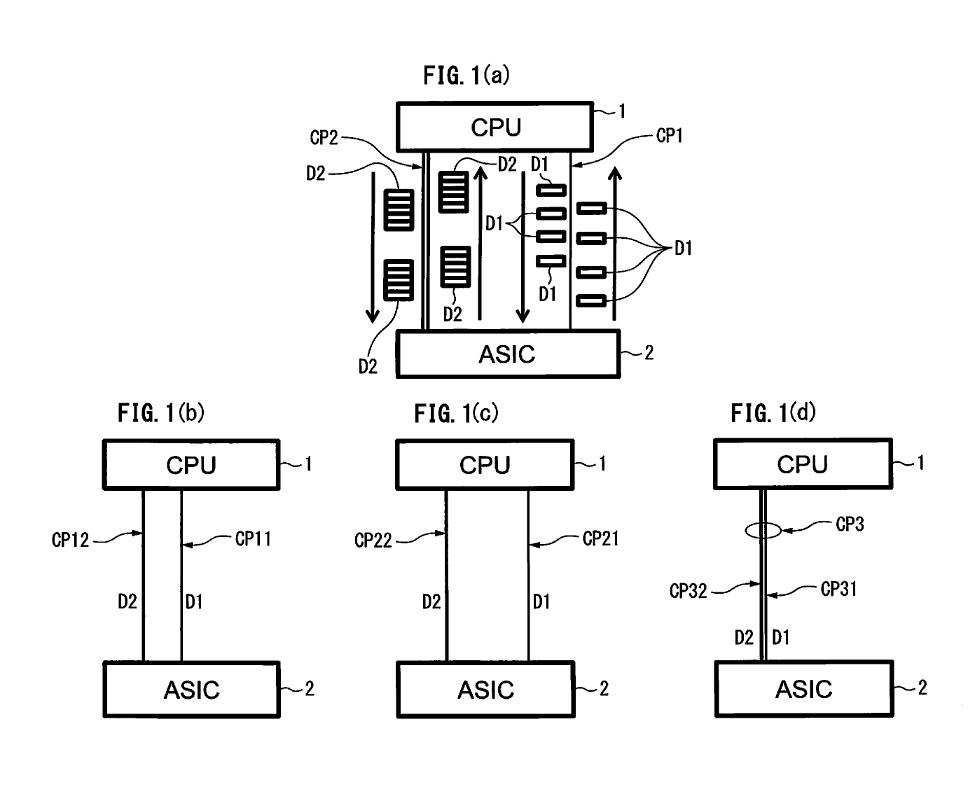

The motor controller according to an example of the present invention will be described in detail hereafter, with reference to the attached drawings. FIGS. 1(a) to 1(d) are block diagrams schematically illustrating the motor controller according to each example of the present invention, wherein FIG. 1(a) schematically illustrates a basic configuration of each example, FIG. 1(b) schematically illustrates a first example, FIG. 1(c) schematically illustrates a second example, and FIG. 1(d) schematically illustrates a third example respectively.

As illustrated in FIG. 1(a), the motor controller of this example includes CPU (main CPU: a first circuit device) 1 and ASIC (a facing device: a second circuit device) 2, and the data communication (transmission and reception of signals) between CPU 1 and ASIC 2 is carried out via the first communication channel CP 1 and the second communication channel CP2 of different communication properties.

In other words, a first communication for transmitting and receiving the low latency first data D1 is carried out between CPU1 and ASIC 2 via the first communication channel CP1 of a low latency property, and a second communication for transmitting and receiving the high throughput second data D2 is carried out between CPU1 and ASIC 2 via the second communication channel CP2 of a high throughput property.

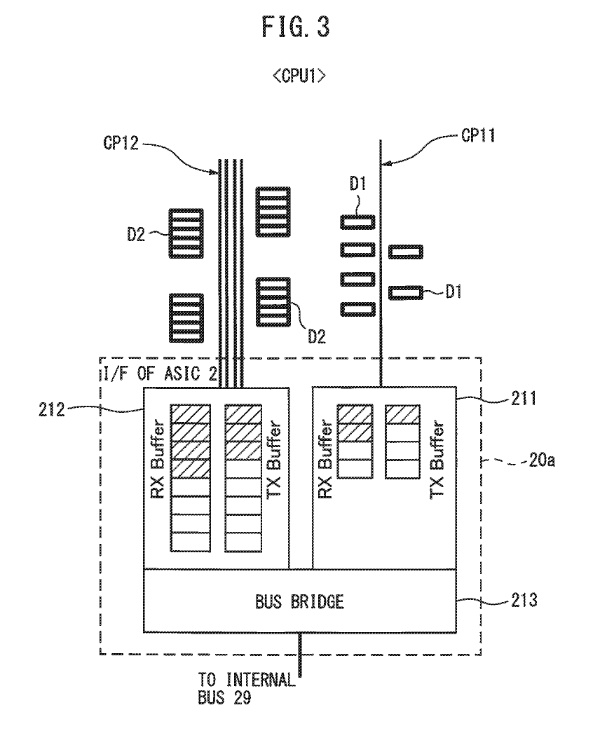

As illustrated in FIG. 1(b), the motor controller of the first example controls so that the first communication channel CP11 for transmitting and receiving first data D1, and the second communication channel CP12 for transmitting and receiving second data D2 are configured between CPU1 and ASIC 2 as a high-speed serial bus (for example, PCI-EX), and each kind of parameter is adjusted so that the first communication channel CP11 is set in a property suitable for the low latency data communication, and the second communication channel CP12 is set in a property suitable for the high throughput data communication. Details of the motor controller of the first example will be described later, with reference to FIG. 3 to FIGS. 5(a) to 5(c).

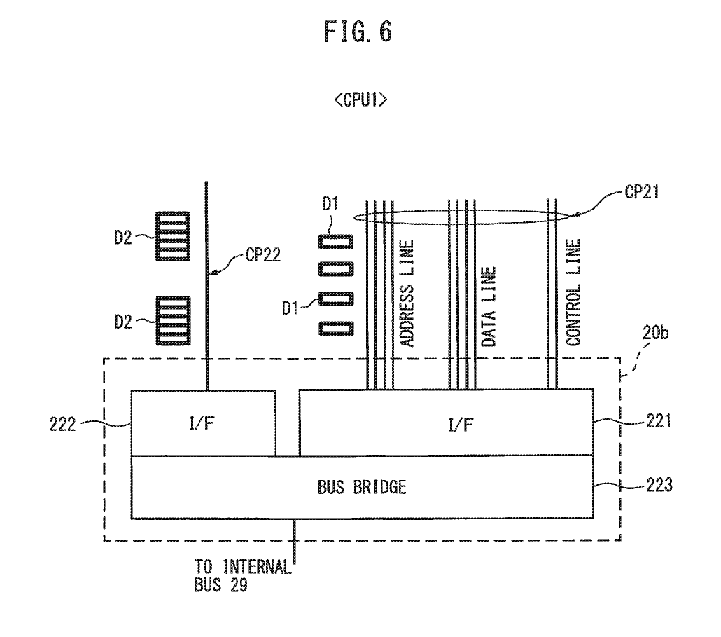

As illustrated in FIG. 1(c), the motor controller of the second example controls so that the first communication channel CP 21 for transmitting and receiving first data D1 is configured between CPU 1 and ASIC 2 as a parallel bus, and the second communication channel CP12 for transmitting and receiving second data D2 is configured between CPU 1 and ASIC 2 as the high-speed serial bus. Details of the motor controller of the second example will be described later, with reference to FIG. 6.

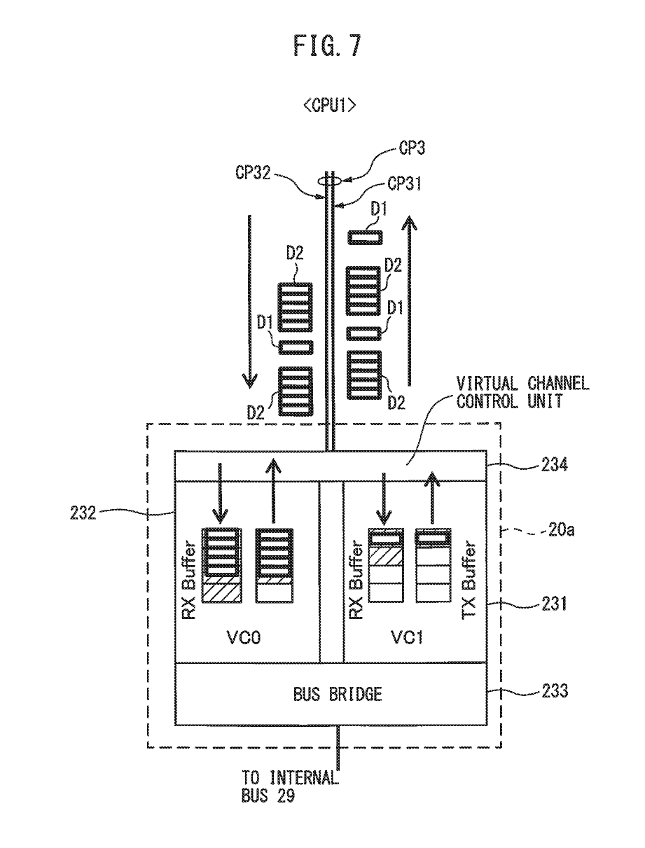

As illustrated in FIG. 1(d), the motor controller of the third example controls so that the data communication is carried out between CPU1 and ASIC via the communication channel CP3, and the communication channel CP3 includes at least two virtual-mode channels CP31 and CP32 as the high-speed serial bus (for example, PCI-EX). Then, data communication is carried out via at least two virtual-mode channels CP31 and CP32, so that a first priority of the first data D1 is placed higher than a second priority of the second data D2 whose size is larger than the size of the first data D1. Details of the motor controller of the third example will be described later, with reference to FIG. 7.

Thus, according to the motor controller of this example, both low latency and high throughput are satisfied in data communication between different circuit devices, corresponding to each property of a different communication channel.

As described above, regarding ASIC 2, a similar one as described above with reference to FIGS. 8(a) and 8(b) can be used, excluding I/F 20. The first circuit device 1 is not limited to the main CPU of the motor controller, and the second circuit device 2 is not limited to ASIC (Application Specific Integrated Circuit) of the motor controller, and other various semiconductor integrated circuits may be acceptable. Further, transmission/reception of signals between the first circuit device 1 and the second circuit device 2 is not limited to low latency and high throughput, and three or more communication channels may be acceptable between the first circuit device 1 and second circuit device 2.

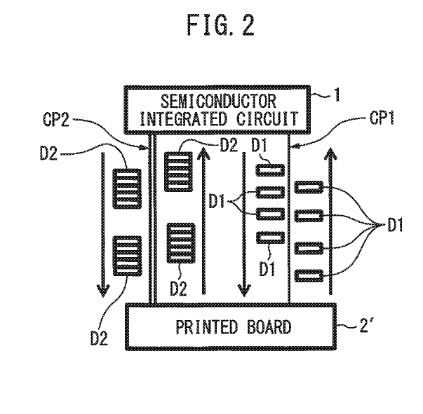

FIG. 2 is a block diagram illustrating a modified example of the motor controller illustrated in FIGS. 1(a) to 1(d). As clarified from a comparison between FIG. 2 and the abovementioned FIG. 1(a), the second circuit device of the abovementioned each example is not limited to ASIC (semiconductor integrated circuit) 2 in which a plurality of circuit blocks are provided, and for example the second circuit device may be a printed board 2′ in which a plurality of semiconductor integrated circuits are provided corresponding to each circuit block described above with reference to FIG. 8(a).

Further, as described above, the first circuit device of each example is not limited to the main CPU 1 of the motor controller, and may be other various semiconductor integrated circuits 1. First communication channels CP11, CP 21, CP31 and second communication channels CP12, CP 22, CP32 of the first example to the third example are schematically described with reference to FIG. 1(b) to FIG. 1(d), and in the modified example, it is acceptable to used them as the first communication channel CP1 and the second communication channel CP2 between the semiconductor integrated circuit 1 and the printed board 2′.

FIG. 3 is a block diagram illustrating an important part of the motor controller according to a first example of the present invention, and illustrating an interface (I/F) 20a in ASIC 2 to which CPU 1 is connected, the first communication channel CP11 and the second communication channel CP12. The configuration of the ASIC 2 corresponds to the configuration described above with reference to FIGS. 8(a) and 8(b), and I/F 20 of FIG. 20 corresponds to I/F 20a illustrated in FIG. 3.

As schematically described above with reference to FIG. 1(b), the motor controller of the first example controls so that both of the first communication channel CP11 for transmitting and receiving the low latency first data D1, and the second communication channel CP12 for transmitting and receiving the high throughput second data D2 are configured as the high-speed serial bus (PCI-EX) between CPU 1 and ASIC 2.

As illustrated in FIG. 3, I/F 20a of ASIC 2 includes a first communication channel buffer unit 211 including a transmission buffer (TX Buffer) and a reception buffer (RX Buffer) for the first communication channel (first PCI-EX) CP11, and a second communication channel buffer unit 212 including a transmission buffer and a reception buffer for the second communication channel (second PCI-EX) CP12, and a bus bridge 213. The bus bridge 213 is a circuit for connecting the first and second communication channels CP11 and CP12 and an internal bus 29 of ASIC 2, via buffer units 211 and 212.

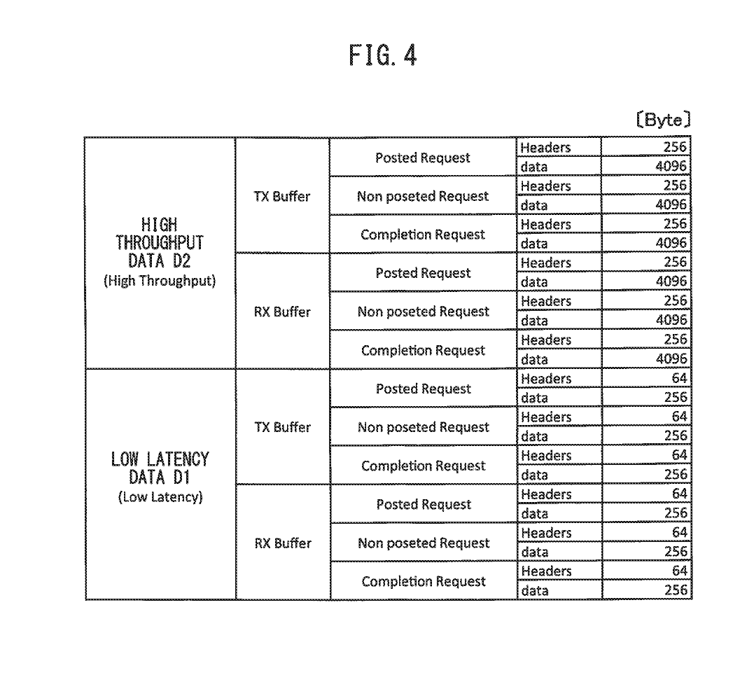

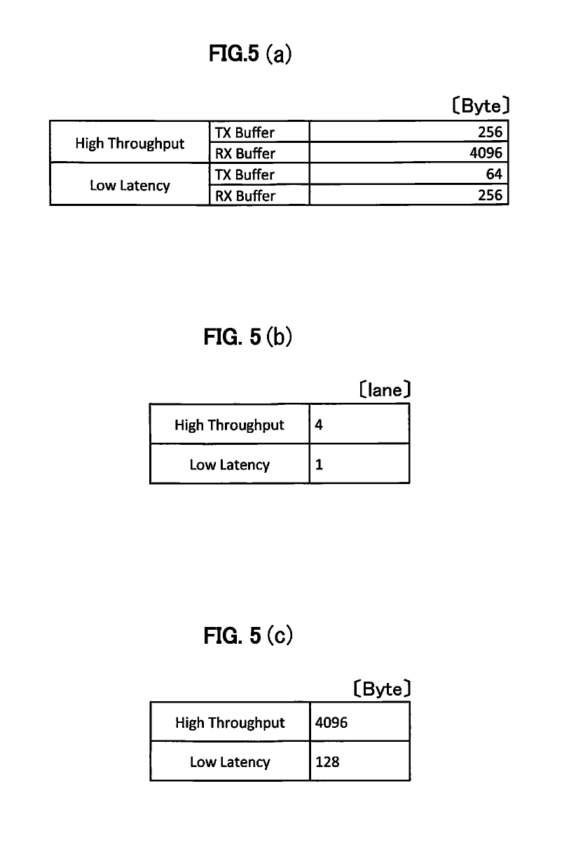

FIG. 4 and FIGS. 5(a) to 5(c) are views for describing a configuration and a setting of the motor controller of the first example illustrated in FIG. 3. FIG. 4 illustrates a configuration example of a buffer size of a different type of packet, and FIG. 5(a) illustrates a configuration example of the buffer size in each transmission/reception, and FIG. 5(b) illustrates a configuration example of the number of lanes, and FIG. 5(c) illustrates a setting example of a payload size.

In FIG. 4 and FIG. 5(a) to FIG. 5(c), “High Throughput” indicates data D2 for which high throughput is requested, and “Low Latency” indicates data D1 for which low latency is requested. Further, “TX Buffer” and “RX Buffer” of the “High Throughput” corresponds to a transmission buffer and a reception buffer in the second communication channel buffer unit 212 illustrated in FIG. 3, and “TX Buffer” and “RX Buffer” of the “Low Latency” correspond to the transmission buffer and the reception buffer in the first communication channel buffer unit 211 illustrated in FIG. 3.

First, as illustrated in FIG. 5(a), regarding the size of the buffer, for example, the size of the transmission buffer (TX Buffer) is set to 256 [Bytes] and the size of the reception buffer (RX Buffer) is set to 4096 [Bytes] for the high throughput data D2 (High Throughput) for example. Further, the size of the transmission buffer (TX Buffer) is set to 64 [Bytes] and the size of the reception buffer (RX Buffer) is set to 256 [Bytes] for the low latency data D1 (Low Latency) for example.

Then, as illustrated in FIG. 4, in the packet of the transmission buffer (TX Buffer) and the reception buffer (RX Buffer) for the data D2 (High Throughput) for which high throughput is requested, each header of Posted Request, NON Posted Request, and Completion Request is set to 256 [Bytes], and each data is set to 4096 [Bytes].

In contrast, in the packet of the transmission buffer (TX Buffer) and the reception buffer (RX Buffer) for the data D1 (Low Latency) for which low latency is requested, each header of Posted Request, NON Posted Request, and Completion Request is set to 64 [Bytes], and each data is set to 256 [Bytes].

For example, Flow Control is performed by PCI-EX to mutually connect and communicate the capacity of the reception buffer. Usually, the flow control is automatically performed by hardware, and therefore control by software is difficult.

Therefore, transmission/reception of signals (data communication) is successively carried out without being kept waiting when the buffer size is large, and therefore the throughput becomes large (high). However, when there is a large volume of data accumulated in the buffer, for example, the waiting time from the transmission of the individual data by CPU 1 to reception of the data by ASIC (a facing device) 2 becomes long, i.e., latency becomes large (high).

Therefore, it is found that preferably the buffer size is increased at the second communication CP12 side where transmission/reception of the high throughput data D2 is carried out, and the buffer size is decreased at the first communication channel CP11 side where transmission/reception of the low latency data D1 is carried out.

In other words, by decreasing the buffer size for the first communication channel (first PCI-EX) CP11, and by increasing the buffer size for the second communication channel (second PCI-EX) CP12, for example even when both communication channels are the same PCI-EX, the first communication channel CP11 can be made suitable for the low latency data D1, and the second communication channel can be made suitable for the high throughput data D2.

Further, as illustrated in FIG. 5(b), regarding a configuration of the number of lanes, for example, the number of lanes is increased (e.g. four) for the high throughput data D2 (High Throughput), and the number of lanes is decreased (e.g. one) for the low latency data D1 (Low Latency).

In other words, a speed difference generated by the number of lanes, is significantly influenced by the size of the packet, as the packet size becomes larger. Therefore, when the total number of lanes is limited, the number of lanes of the second communication channel CP12 for transmitting and receiving the high throughput data D2 is increased, and the number of lanes of the first communication channel CP11 for transmitting and receiving the low latency data D1 is decreased. Thus, the first communication channel CP11 can be made suitable for the low latency data D1, and the second communication channel CP12 can be made suitable for the high throughput data D2.

Further, as illustrated in FIG. 5(c), regarding the payload size (maximum payload size), for example the payload size is set to be large (e.g. 4096 [Bytes] for the high throughput data D2 (High Throughput), and the payload size is set to be small (e.g. 128 [Bytes]) for the low latency data D1 (Low Latency).

In other words, for example, according to the standard of PCI-EX, the maximum size (payload size) of the packet can be specified by a configuration register, so that the payload size on the first communication channel CP11 side is decreased, and the payload size on the second communication channel CP12 side is increased. Accordingly, the first communication channel CP11 can be made suitable for the low latency data D1, and the second communication channel CP12 can be made suitable for the high throughput data D2.

According to the motor controller of the first example, even when both of the first communication channel CP11 for transmitting and receiving the low latency first data D1, and the second communication channel CP12 for transmitting and receiving the high throughput second data D2 between CPU1 and ASIC 2 are configured as the high-speed serial bus (PCI-EX), the first data D1 can be transmitted and received with low latency, and the second data D2 can be transmitted and received with high throughput by adjusting parameters for the communication channel, such as the buffer size, the payload size, and the number of lanes.

Thus, according to the motor controller of the first example, both of the low latency data communication and the high throughput data communication can be satisfied between different circuit devices corresponding to each property of a different communication channel, and a performance of the motor controller that controls the motor in the machine tool or the robot can be improved. The same is applied to other examples and modified examples.

It is a matter of course that the high-speed serial bus is not limited to PCI-EX, and the adjusted parameter is not limited to the buffer size, the payload size, and the number of lanes. Further, according to the motor controller of the first example, the low latency data communication and the high throughput data communication can be carried out via the communication channel of a different property corresponding to each property. The same is applied to the second example described hereafter.

FIG. 6 is a block diagram illustrating an important part of the motor controller according to a second example of the present invention, and illustrating I/F 20b in ASIC 2 to which CPU1 is connected, the first communication channel CP 21, and the second communication channel CP 22. The configuration of the ASIC 2 corresponds to the configuration described above with reference to FIGS. 8(a) and 8(b), and I/F 20 illustrated in FIGS. 8(a) and 8(b) corresponds to I/F 20b illustrated in FIG. 6.

As schematically described above with reference to FIG. 1(c), the motor controller of the second example is configured so that the first communication channel CP 21 for transmitting and receiving the low latency first data D1 between CPU1 and ASIC 2 is configured as the parallel bus, and the second communication channel CP 22 for transmitting and receiving the high throughput second data D2 between CPU1 and ASIC 2 is configured as the high-speed serial bus (PCI-EX).

As illustrated in FIG. 6, I/F 20b of ASIC 2 includes the first communication channel I/F 221 for the first communication channel (parallel bus) CP 21, the second communication channel I/F 222 for the second communication channel (PCI-EX)CP 22, and the bus bridge 223. The bus bridge 223 is a circuit for connecting the first and second communication channels CP 21 and CP 22, and the internal bus 29 of ASIC 2, via the first and second communication channels I/F 221 and I/F 222.

The parallel bus of various standards, for example such as PCI (Peripheral Component Interconnect), IFC (International Field-bus Consortium), ATA (Advanced Technology Attachment), 60x bus, and a boot interface (Boot I/F), etc., may be used as the first communication channel CP 21.

The high-speed serial bus such as PCI-EX is an interface configured by only one pair or a plurality of differential pairs, and it takes a predetermined time to perform a serial/parallel conversion, thus causing a certain time loss in transmitting and receiving signals. However, signal frequency (transmission rate) can be set to about 8 GHz for example. In contrast, the parallel bus such as PCI is configured for example by a plurality of address lines, a plurality of data lines, and a plurality of control lines, with no need for converting data (signal), i.e. with less time loss. However, the frequency of the signal is, for example, about 100 MHz and slow.

Therefore, according to the motor controller of the second embodiment, the first communication channel CP 21 is made suitable for the low latency data D1 by configuring the first communication channel CP 21 as the parallel bus, and the second communication channel CP 22 is made suitable for the high throughput data D2 by configuring the second communication channel CP 22 as the high-speed serial bus, between CPU1 and ASIC 2.

FIG. 7 is a block diagram illustrating an important part of the motor controller according to a third example of the present invention, and illustrating I/F 20c in ASIC 2 to which CPU 1 is connected, and the first communication channel CP31 and the second communication channel CP32. The configuration of ASIC 2 corresponds to the configuration described above with reference to FIGS. 8(a) and 8(b), and I/F 20 of FIGS. 8(a) and 8(b) corresponds to I/F 20c illustrated in FIG. 7.

As schematically described above with reference to FIG. 1(d), the motor controller of the third example carries out data communication between CPU 1 and ASIC 2 via the communication channel CP3, and the communication channel CP3 includes at least two virtual-mode channels CP31 and CP32 as the high-speed serial bus (for example, PCI-EX). Data communication is carried out via at least two virtual-mode channels CP31 and CP32, so that the first priority of the first data D1 is placed higher than the second priority of the second data D2 whose size is larger than the size of the first data D1.

As illustrated in FIG. 7, by using two virtual-mode channels CP31 and CP32 as PCI-EX, I/F 20c of ASIC 2 includes first and second virtual channel buffer units 231 and 232 corresponding to the first and second communication channel buffer units 211 and 212 of the first example described above with reference to FIG. 3. I/F 20c further includes a bus bridge 233 and a virtual channel control unit 234.

The virtual channel control unit 234 is configured to control the high-speed serial bus CP3 that connects CPU 1 and AISC 2, using two virtual-mode channels CP31 and CP32, and for example, performs processing so that the priority of small-sized first data D1 is placed higher than the priority of large-sized second data D2. Further, the bus bridge 233 is a circuit for connecting the high-speed serial bus CP3 and the internal bus 29 of ASIC 2, via buffer units 231, 232 and the virtual channel control unit 234.

For example, according to the PCI-EX standard, there is a function of a virtual channel (virtual-mode) for using one channel like a plurality of channels, in which the priority of access can be set in each channel. For example, the motor controller of the third example is provided with the first virtual channel buffer unit 231 for small-sized data D1, and the second virtual channel buffer unit 232 for large-sized data D2, corresponding to two virtual-mode channels CP31 and CP32 as the high-speed serial bus (PCI-EX).

The small-sized data D1 corresponds to the low latency data, and the large-sized data D2 corresponds to the high throughput data. Regarding the data D1 and the data D2, the priority is determined by the virtual channel control unit 234, and for example, the priority of the low latency small-sized data D1 is placed high and the priority of the high throughput large-sized data D2 is placed low.

Accordingly, data communication of the low latency small-sized data D1 is carried out in a short delay so as not to be kept waiting by the data communication of the large-sized data D2 for example. In other words, the motor controller of the third example satisfies both of the low latency data communication in which low latency is requested and the high throughput data communication in which high throughput is requested, corresponding to each property of a different communication channel.

In other words, according to the motor controller of the third example, data can be efficiently transmitted so that small data is not kept waiting by large data, with a result that data communication of the low latency small-sized data is carried out in a short delay. Two virtual-mode channels CP31 and CP32 as PCI-EX are given as an example of the virtual channels as the high-speed serial bus CP3. However, the present invention is not limited thereto.

According to the motor controller of the first aspect, both of the data communication in which low latency is requested, and the data communication in which high throughput is requested, can be satisfied between different circuit devices, corresponding to each property of a different communication channel. Further, according to the motor controller of the first aspect, the data communication in which low latency is requested and the data communication in which high throughput is requested can be carried out via the communication channel of a different property corresponding to each property.

In other words, the data communication in which low latency is requested, can be carried out via the first communication channel of a low latency property, and the data communication in which high throughput is requested, can be carried out via the second communication channel of a high throughput property. Accordingly, the performance of the motor controller that controls a motor in a machine tool or a robot, etc., can be improved.

According to the motor controller of the present invention, the effect of attaining (satisfying) both low latency and high throughput in data communication between different circuit devices, can be satisfied corresponding to each property of a different communication channel.

According to the second aspect, similar to the first aspect, both of the data communication in which low latency is requested, and the data communication in which high throughput is requested, can be satisfied between different circuit devices, corresponding to each property of a different communication channel. Further, according to the motor controller of the second aspect, data can be efficiently transmitted so that small data is not kept waiting by large data, with a result that data communication of the low latency small-sized data is carried out in a short delay.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A motor controller comprising a first circuit device and a second circuit device, and configured to carry out data communication between the first circuit device and the second circuit device via at least two communication channels of different communication properties, wherein
the data communication between the first circuit device and the second circuit device includes a first data communication in which low latency is requested and a second data communication in which high throughput is requested,
the first data communication is carried out between the first circuit device and the second circuit device via a first communication channel of a low latency property, and
the second data communication is carried out between the first circuit device and the second circuit device via a second communication channel of a high throughput property.

2. The motor controller according to claim 1, wherein
the first communication channel is a first serial bus of a low latency property which is obtained by adjusting a first buffer size, a first payload size, and the number of first lanes, and
the second communication channel is a second serial bus of a high throughput property which is obtained by adjusting a second buffer size, a second payload size, and the number of second lanes.

3. The motor controller according to claim 2, wherein the first buffer size is smaller than the second buffer size.

4. The motor controller according to claim 2, wherein the second payload size is larger than the first payload size, or the number of second lanes is larger than the number of first lanes.

5. The motor controller according to claim 2, wherein the first serial bus and the second serial bus are PCI Express (registered trademark).

6. The motor controller according to claim 1, wherein
the first communication channel is a parallel bus, and
the second communication channel is a high-speed serial bus.

7. The motor controller according to claim 6, wherein
the parallel bus is one of PCI, IFC, ATA, 60x, and a boot interface, and
the high-speed serial bus is one of PCI Express (registered trademark), HyperTransport (registered trademark), and Rapid I0 (registered trademark).

8. The motor controller according to claim 1, wherein
first data transmitted through the first data communication includes data regarding one of a register or a peripheral, and
second data transmitted through the second data communication includes data regarding one of a servo, a spindle, I/O, or graphics.

9. The motor controller according to claim 1, wherein
the first circuit device is a first semiconductor integrated circuit, and
the second circuit device is a printed board in which a plurality of semiconductor integrated circuits are provided.

10. The motor controller according to claim 1, wherein
the first circuit device is a first semiconductor integrated circuit, and
the second circuit device is a second semiconductor integrated circuit in which a plurality of circuit macros are provided.

11. The motor controller according to claim 10, wherein the second semiconductor integrated circuit is an Application Specific Integrated Circuit of the motor controller.

12. The motor controller according to claim 11, wherein
the Application Specific Integrated Circuit includes:
one of a servo control unit that controls a servo motor or a spindle motor, a graphic engine that applies processing to images, and an I/O communication master that controls I/O communication, which are configured to handle high throughput data; and
a peripheral that handles data for which low latency is requested.

13. The motor controller according to claim 9, wherein the first semiconductor integrated circuit is a main CPU of the motor controller.

14. A motor controller, comprising a first circuit device and a second circuit device, and configured to carry out data communication between the first circuit device and the second circuit device via a communication channel, wherein
the communication channel includes at least two virtual-mode channels in a high-speed serial bus, and
data communication is carried out via at least two virtual-mode channels, so that a first priority of first data is placed higher than a second priority of second data whose size is larger than the size of the first data.

15. The motor controller according to claim 14, wherein the high-speed serial bus is PCI Express (registered trademark), the first data is data for which low latency is requested, and the second data is data for which high through put is requested.

16. The motor controller according to claim 8, wherein
first data transmitted through the first data communication includes data regarding one of a register or a peripheral, and
second data transmitted through the second data communication includes data regarding one of a servo, a spindle, I/O, or graphics.

17. The motor controller according to claim 8, wherein
the first circuit device is a first semiconductor integrated circuit, and
the second circuit device is a printed board in which a plurality of semiconductor integrated circuits are provided.

18. The motor controller according to claim 8, wherein
the first circuit device is a first semiconductor integrated circuit, and
the second circuit device is a second semiconductor integrated circuit in which a plurality of circuit macros are provided.

19. The motor controller according to claim 18, wherein the second semiconductor integrated circuit is an Application Specific Integrated Circuit of the motor controller.

20. The motor controller according to claim 19, wherein
the Application Specific Integrated Circuit includes:
one of a servo control unit that controls a servo motor or a spindle motor, a graphic engine that applies processing to images, and an I/O communication master that controls I/O communication, which are configured to handle high throughput data; and
a peripheral that handles data for which low latency is requested.

21. The motor controller according to claim 17, wherein the first semiconductor integrated circuit is a main CPU of the motor controller.
